(19) United States
(12) Patent Application Publication
(10) Pub. No.: US 2001/0030969 A1
(43) Pub. Date: Oct. 18, 2001

(54) Systems and methods for implementing global virtual circuits in packet-switched networks

(76) Inventors: Robert J. Donaghey, Lexington, MA (US); Norman Rehn, Newbury, MA (US)

Correspondence Address: Leonard Charles Suchyta, Verizon Services Group, 600 Hidden Ridge HQE03H01, Irving, TX, 75038, US

(21) Appl. No.: 09/725,762

(22) Filed: Nov. 30, 2000

Related U.S. Application Data
(60) Provisional application No. 60/167,918, filed on Nov. 30, 1999.

(51) Int. Cl. H04L 12/28; H04L 12/56

(52) U.S. Cl. 370/397; 370/399

(57) ABSTRACT

A router (105) includes multiple network interfaces (230-245) and a processor (220). Each of the network interfaces (230-245) receives port connection information associated with switches in a network (100). The processor (220) updates information pertaining to locations and paths to switches in the network (100) based on the received portion connection information. The processor further updates, based on the received port connection information, entries in a virtual circuit table such that the router provides virtual circuit paths to all switches in the network (100) within a radius of connection from the router (105).

### FIELD OF THE INVENTION

The present invention relates generally to packet switching systems and methods and, more particularly, to systems and methods for routing IP traffic over connection-oriented packet switches in mobile ad-hoc networks using virtual circuits.

### BACKGROUND OF THE INVENTION

Connection-oriented protocols have conventionally been used for switching packets from a source node to a destination node in packet switching networks. Such networks have found acceptance in the mobile arena with network hardware installed in trucks and other vehicles or hand-carried. Connections between switches in such environments are often short-lived as equipment is moved together or apart, and are of widely fluctuating throughput quality. The challenge of routing is substantially greater than that of stationary systems. Connection-oriented designs for such systems have been favored because of the need to support telephony as well as machine-to-machine communications. However, IP has become the protocol of choice for end users of such systems, so the need to route IP packets across mobile, ad hoc switching networks has been met by adding IP routers on top of the connection-oriented switches, and developing protocols for establishing the optimal path from one router to another.

The algorithms used by routers to convey connectivity in a mobile network must be able to keep up with the constantly changing topology, and, as the IP addresses themselves will not convey any topological information when a router can move about freely, they typically use flooding techniques (sometimes called ‘Shortest Path First’ algorithms) to pass local connectivity information on to more distantly-connected routers. A router then uses this information when sending or forwarding packets to another router to decide which way to send the packet. Typically a router will determine which of its nearest neighbors is ‘closest’ to the destination, and then forward the packet one hop to the chosen neighbor. To do so when the router is attached to a connection-oriented switch, as is the case here, the router must select a virtual circuit on which to place the packet. To facilitate this, it is the current practice for each switch to automatically set up a permanent one-hop circuit to each of its immediate neighbors, with the neighbor forwarding all packets arriving on this circuit to its connected IP router.

The use of multi-hop circuits for faster IP packet transport has faced a number of substantial obstacles: Portable equipment lags the stationary world in terms of size and speed, and mobile switch equipment usually has sufficient memory only for small Virtual Circuit (VC) tables. Hence, circuits have to be used selectively. The paths between switches are in constant flux in a fast moving mobile environment (as, for example, in military or fire-fighting environments), so connections are constantly being broken and re-established. IP is not connection-oriented, so setting up connections as packets arrive for some new destination has proved infeasible since the standard protocols for negotiating a virtual circuit across multiple hops take substantially longer than TCP timeouts tolerate. Knowledge of breaks in connectivity is known first to the switches closest to the break, so packets forwarded by more distant routers will often arrive with the expectation of a (now-broken) path to the destination, and the receiving router must be able to acquire control of the packet, rather than have its connected switch forward the packet further down a no-longer-complete virtual circuit. Nevertheless, fast communications is a must in ad hoc networks, and there is a real need for better integration of the capabilities of the underlying connection-oriented switching network and their connected IP routers. Reliable connection is largely absent in this environment as well, so there is a need for more robust algorithms for insuring the delivery of information.

Therefore, there exists a need for a system and method that can implement multi-hop virtual circuit paths in a mobile, ad hoc, connection-oriented packet switching network to support fast and reliable connectivity of IP routers.

### SUMMARY OF THE INVENTION

Systems and methods, consistent with the present invention, address this and other needs by allocating a portion of the virtual circuit table at every ‘node’ in the packet switching network, where a node exists within a switch at each incoming network interface. The present invention eliminates the need for connection request messages by implementing a common algorithm at each node in the network that automatically assigns virtual circuit identifiers for forwarding IP packets to and through each and every sequence of switches within some radius of each switch in the network, based only on flooded port connectivity information. The exemplary algorithms of the present invention permit each router in the network to control the setup of a portion of its switch's virtual circuit tables according to a globally understood convention that permits each router to forward packets through multi-hop virtual circuits to routers any number of hops (up to some limit determined by the available VC capacity), yet giving each intervening switch's router the ability to take control of, and redirect, the path of packets addressed to no-longer-connected destinations, and without requiring the use of connection-request messages.

In accordance with the purpose of the invention as embodied and broadly described herein, a method of establishing virtual circuit paths at a first node in a packet-switched network includes receiving, at the first node, port connection information associated with switches in the network; determining at least one virtual circuit path to at least one switch in the network based on the received port connection information; and determining, for the at least one virtual circuit path, a first output port of the first node and an outgoing virtual circuit identifier (VCIₒᵤₜ) to use to send a packet from the first node to a destination node in the network.

In another implementation consistent with the present invention, a method of updating a virtual circuit table associated with a first switch in a packet-switched network includes receiving port connection information associated with switches in the network; updating previously stored information regarding locations and paths to switches in the network based on the received portion connection information; and updating, based on the received port connection information, entries in the virtual circuit table such that the first switch provides virtual circuit paths to all switches in the network within a radius of connection from the first switch.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary network in which systems and methods, consistent with the present invention, may be implemented;

FIG. 2 illustrates exemplary components of an IP router and its connection-oriented switch consistent with the present invention;

FIG. 3 illustrates an exemplary Virtual Circuit (VC) table consistent with the present invention;

FIG. 4 illustrates an exemplary flood packet consistent with the present invention;

FIGS. 5-6 are flowcharts that illustrate exemplary incoming/outgoing VCI assignment processing consistent with the present invention; and

FIG. 7 is a flowchart that illustrates exemplary switch packet forwarding processing consistent with the present invention.

FIG. 8 is a flowchart that illustrates exemplary router packet forwarding processing consistent with the present invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Systems and methods, consistent with the present invention, provide mechanisms that permit each router in a network to control the setup of a portion of its switch's virtual circuit tables according to a globally understood convention that permits each router to forward packets through multi-hop virtual circuits to routers any number of hops away (up to some limit determined by the available VC capacity). The present invention further gives each intervening switch's router the ability to take control of, and redirect, the path of packets addressed to no-longer-connected destinations without requiring the use of connection-request messages.

### Exemplary Network

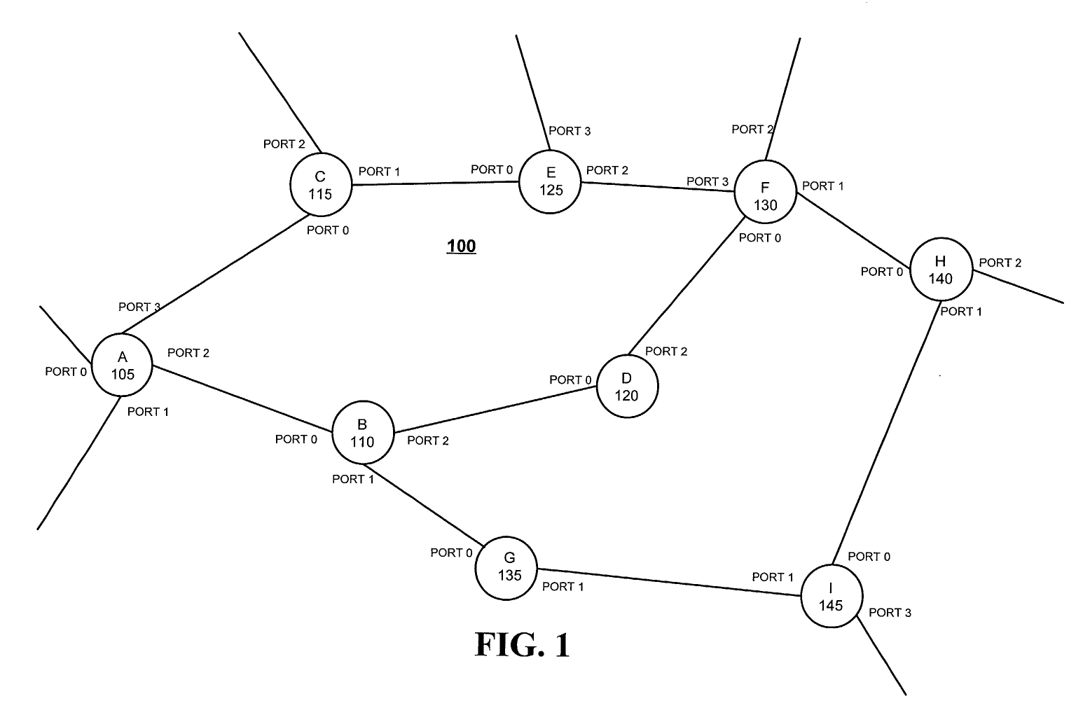

FIG. 1 illustrates an exemplary network 100 in which systems and methods, consistent with the present invention, may be implemented. Network 100 may include multiple routers, each router interconnected with another router by a link. For purposes of illustration, FIG. 1 shows routers A 105-I 145, each interconnected by links via ports numbered 0-n (e.g., port 0, port 1, port n). One skilled in the art will recognize that a typical network may include fewer or greater numbers of routers than those shown in FIG. 1.

### Exemplary Router

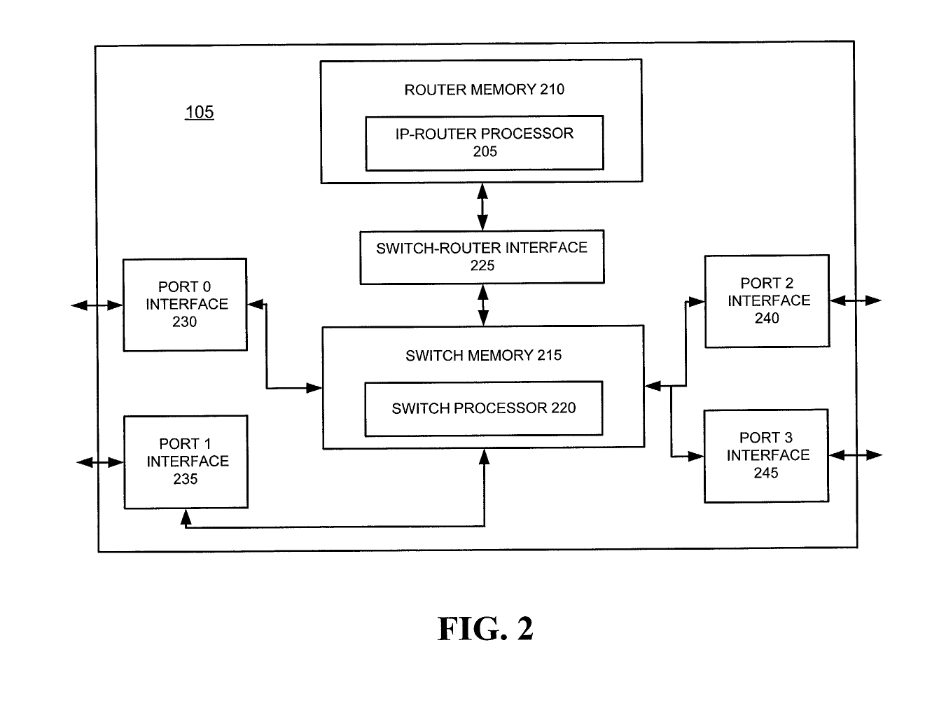

FIG. 2 illustrates an exemplary router A 105 that may route IP packets in a manner consistent with the present invention. Routers B 110-I 145 may be similarly configured. Router A 105 may include an IP-router processor 205, a router memory 210, a switch memory 215, a switch processor 220, a switch-router interface 225, and port interfaces 230, 235, 240 and 245. It will be appreciated that the router 105 may include additional components (not shown) that aid in the reception, transmission and/or processing of IP packets. One skilled in the art will recognize that a typical switch may include fewer or greater numbers of ports than those shown in FIG. 2.

IP-router processor 205 may execute instructions for performing IP routing algorithms and can include a conventional processing device. Switch processor 220 may execute instructions for performing, among other functions, virtual circuit path switching and can include a conventional processing device. Router memory 210 may provide permanent, semi-permanent, or temporary working storage of data and instructions for use by IP-router processor 205. Switch memory 215 may provide permanent, semi-permanent, or temporary working storage of data and instructions for use by switch processor 220. Router memory 210 and switch memory 215 may include conventional data storage devices, such as, for example, Random Access Memory (RAM) or Dynamic RAM (DRAM).

Switch-router interface 225 may include conventional mechanisms for interfacing IP-router processor 205 with switch processor 220. Port 0 interface 230, port 1 interface 235, port 2 interface 240 and port 3 interface 245 may each include conventional mechanisms for interfacing router 105 with network 100 via a link.

### Exemplary VCI Table

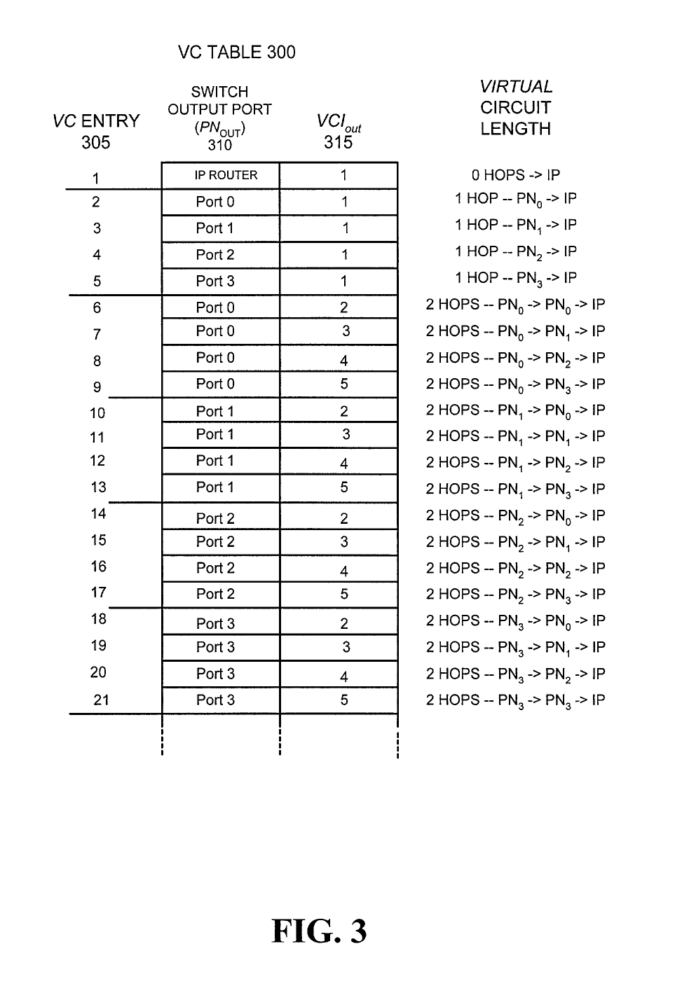

FIG. 3 illustrates an exemplary VC table 300 consistent with the present invention. A different VC table 300 may be stored in switch memory 215 for each port interface 230-245 of switch A 105. VC table 300 VC entries 305 may include switch output port data (PNₒᵤₜ) 310, and outgoing VCI data (VCIₒᵤₜ) 315. Router A 105 may assign a VCIₒᵤₜ 315 and an output port 310 to a VC entry 305 in accordance with the present invention. A VC table 300 may further be stored in each switch memory 215 for each port interface of routers B 110-I 145.

### Exemplary Flood Packet

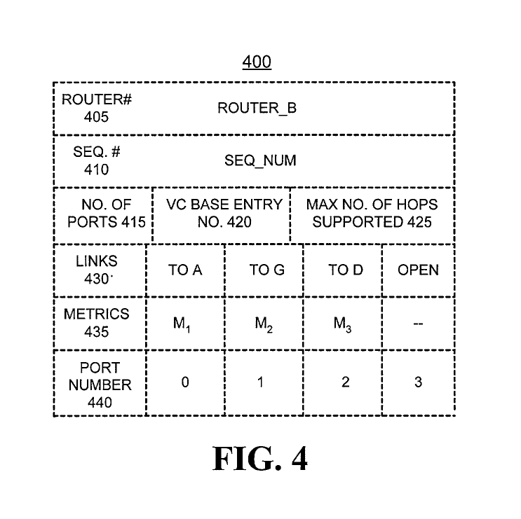

FIG. 4 illustrates an exemplary flood packet 400, consistent with the present invention, that may be used by routers in network 100, such as router A 105, for flooding link state information and router port connection information to other routers in network 100. Flood packet 400 may include a router number 405, a sequence number 410, a number of ports 415, a VC base entry number 420, a maximum number of hops supported 425, link data 430, link metric data 435, and port numbers 440.

Router number 405 can identify the router sending the flood packet 400. Sequence number 410 may provide an indication of the version of flood packet 400 sent from the router identified by router number 405. For example, older versions of a flood packet sent from router A 105 may have lower sequence numbers than newer versions of the flood packet. Number of ports data 415 can include the number of ports the switch identified by router # 405 may use for receiving and/or sending packets. VC base entry data 420 can include the lowest VC entry 305 in VC table 300 allocated for IP circuits. Maximum number of hops supported data 425 can include the maximum number of hops the router identified by router #405 can support in its VC table 300. From this and the VC base entry data 420, one can calculate the highest VC entry 305 in VC table 300 allocated for IP circuits. Link data 430 can indicate the routers connected by a direct link to the router identified by router number 405. Link data 430 may indicate ports to which no other switch is connected. Link metric data 435 can indicate the metrics for each link (e.g., latency) connected to the router identified by router number 405. Port numbers 440 can provide each port number of the switch identified by router number 405 that can be used to forward packets over each direct link identified in link data 430.

### Exemplary Incoming/Outgoing VCI Assignment Processing

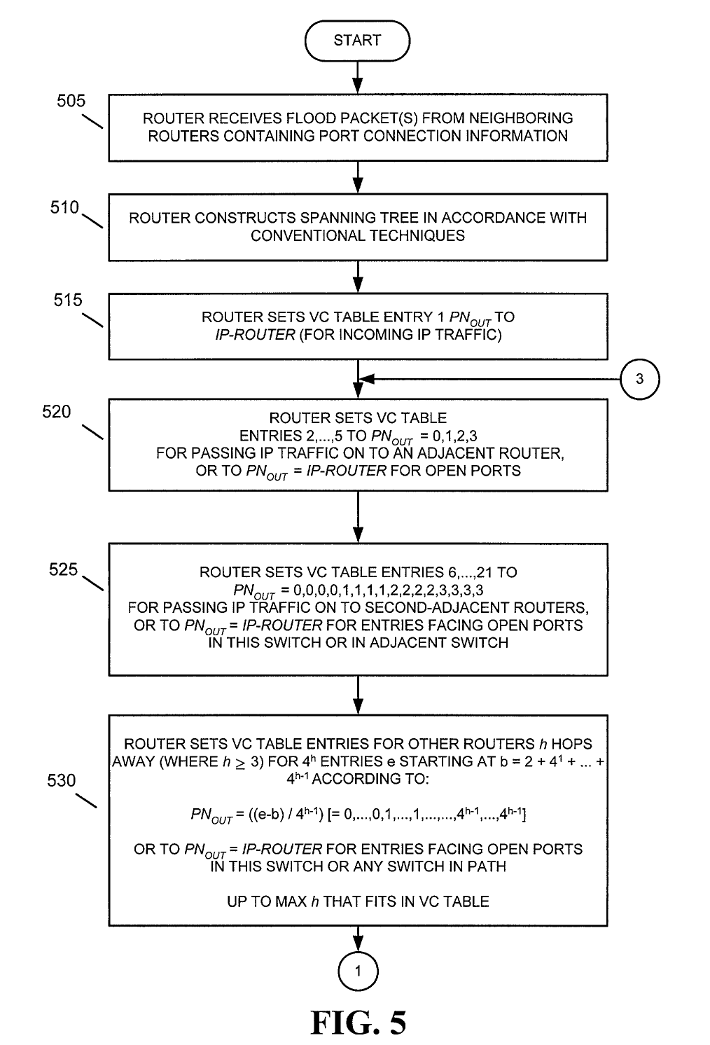

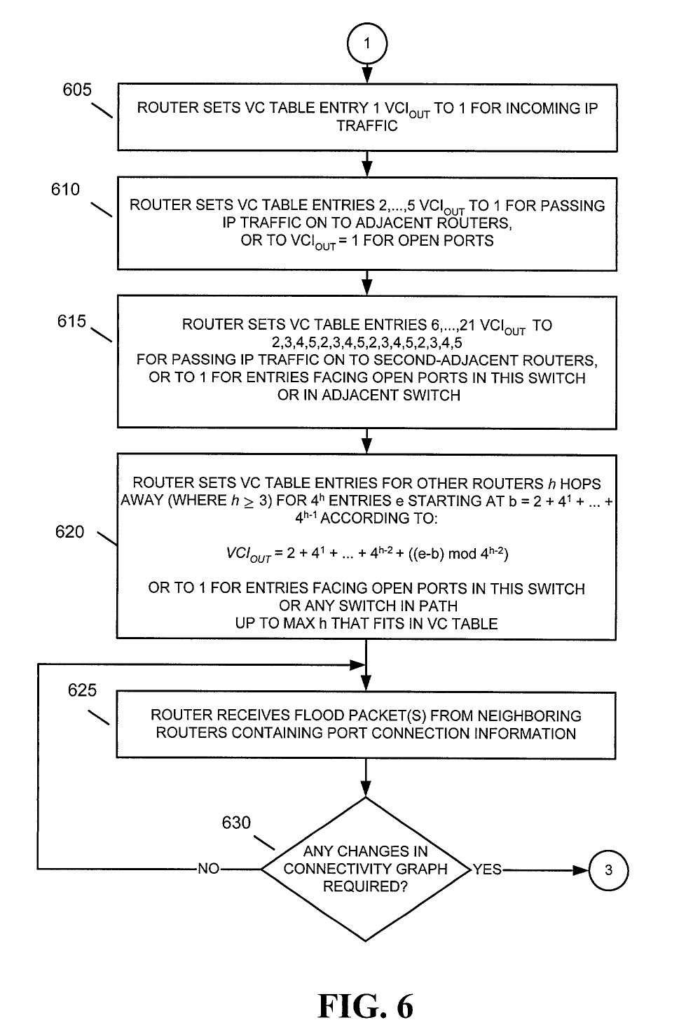

FIGS. 5-6 are flowcharts that illustrate exemplary processing, consistent with the present invention, for assigning output ports and outgoing VCIs to each VC entry 305 in each VC table 300 associated with each port (port 0-port 2) of a router, such as router B 110. As one skilled in the art will appreciate, the method exemplified by FIGS. 5-6 can be implemented as a sequence of instructions and stored in switch memory 215 of router B 110. The method exemplified by FIGS. 5-6 may further be stored in switch memory 215 of router A 105 and routers C 115-I 145.

To begin processing, router B 110 receives flood packets 400 from neighboring routers (e.g., routers A 105, D 120 and G 135) containing port connection information [step 505](FIG. 5). For example, a flood packet 400 may include a number of ports 415 for the router sending the flood packet, link data 430, link metric data 435 and data 440 detailing the port numbers the router sending the packet uses to reach each destination. Router B 110 may then construct a connectivity graph in accordance with conventional techniques using link data 430 and link metric data 435 [step 510]. For example, router B 110 may construct a conventional spanning tree.

Router B 110 may allocate any block of VC entries for IP circuits, indicating the lowest VC entry (Eₘᵢₙ) in its flood packet 400 in the VC base entry data 420. Router B 110 may allocate entries for up to P ports, where P is the no. of ports 415 for which IP circuits are being established. One skilled in the art will recognize that any number of ports can be supported by each switch, and that each switch can use a different lowest VC entry Eₘᵢₙ in its VC tables 400. One skilled in the art will recognize also that virtual circuits never have a link exiting the same port the prior link enters from, so port sequences of the form p₁, p₂, p₁ need not be supported, and that taking this into account can allow for more compact use of the VC tables. For clarity, though, the following will assume that each router starts at entry one, that each router supports four ports, that all ports use the same VC table, and that sequences P₁, p₂, p₁ are handled in the same way as sequences containing open ports.

Router B 110 may then allocate:

1 VC entry for switching incoming packets to its IP-router

4 VC entries for switching incoming packets out to an adjacent switch to be routed to its IP-router

4² VC entries for switching incoming packets out to an adjacent switch to be routed further to one of its neighbors, there to be routed to the second-adjacent switch's IP-router

4³ VC entries for switching incoming packets to ip-routers three hops away

4^{H} VC entries for switching incoming packets to ip-routers H hops away

For the one VC entry for switching incoming packets to its IP-router, Router B 110 may set entry one to switch output port data (PNₒᵤₜ) 310=IP-router, and outgoing VCI data (VCIₒᵤₜ) 315=IP #[steps 515 and 605].

For the 4 VC entries for switching incoming packets out to an adjacent switch to be routed to its IP-router, Router B 110 may, for i=0,1,2,3, set entry (1)+(i) to PNₒᵤₜ=i and VCIₒᵤₜ=(1) [steps 520 and 610].

For the 4² VC entries for switching incoming packets out to an adjacent switch to be routed further to one of its neighbors, there to be routed to the second-adjacent switch's IP-router, Router B 110 may, for i=0,1,2,3 and j=0,1,2,3, set entry (1+4¹)+4i+(j) to PNₒᵤₜ=i and VCIₒᵤₜ=(1)+(j) [steps 525 and 615].

For the 4³ VC entries for switching incoming packets to ip-routers three hops away, Router B 110 may, for i=0,1,2,3 and j=0,1,2,3 and k=0,1,2,3, set entry (1+4+4²)+4²i+(4j+k) to PNₒᵤₜ=i and VCIₒᵤₜ=(1+4)+(4j+k) [steps 530 and 620].

For the 4^{H} VC entries for switching incoming packets to ip-routers H hops away, Router B 110 may, for i=0,1,2,3 and h=0, . . . , 4_{H-1}−1, set entry (1+4+4²+ . . . +4^{H-1})+4^{H-1}i+(h) to PNₒᵤₜ=i and VCIₒᵤₜ=(h) [steps 530 and 620]. Router B 110 may limit the setting of VCIₒᵤₜ entries 315 for other routers h hops away to a maximum number of hops that can fit into available memory space allocated to VC table 300 in switch memory 215.

For any sequence p₁, p₂, . . . , p_{H} of port numbers, the above assignment at every node in a network results in a virtual circuit out port p₁ of switch 1 to, and out port p₂ of, switch 2 to . . . to, and out port p_{H} of, switch H to the IP-router of the attached switch H+1. For every such circuit for which the link data 430 in any of the involved routers' flood packet 400 indicates a port p₁ to which no other switch is connected, Router B 110 may set the corresponding entry

(1+4+4²+ . . . +4^{H-1}) Eqn. (1)

+

(4^{H-1}p₁+4^{H-2}p₂+ . . . 4p_{H-1}+p_{H}) Eqn. (2)

to data PNₒᵤₜ=IP-router, and VCIₒᵤₜ=IP # in order to prevent the use of virtual circuits that lead to dead-ends.

Subsequent to assignment of PNₒᵤₜ entries 310 and VCIₒᵤₜ entries 315 in VC table 300, router B 110 can receive further flood packets from neighboring routers containing port connection information [step 625]. Router B 110 may then determine, based on the newly received port connection information, whether any changes in the previously constructed connectivity graph are required [step 630]. Changes will be needed as ports become connected or disconnected. If not, processing returns to step 625. If changes in the connectivity graph are required, then processing returns to step 520.

### Exemplary Switch Packet Forwarding Processing

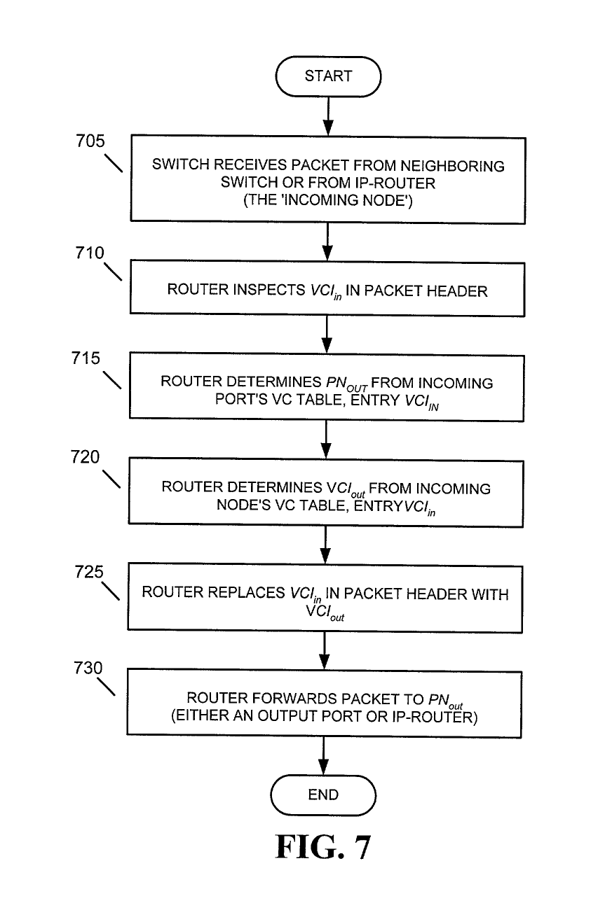

FIG. 7 is a flowchart that illustrates exemplary processing, consistent with the present invention, for forwarding packets using outgoing VCIs 315 retrieved from VC table 300. As one skilled in the art will appreciate, the method exemplified by FIG. 7 can be implemented as a sequence of instructions and stored in switch memory 215 of router B 110. The method exemplified by FIG. 7 may further be stored in switch memory 215 of other routers in network 100, such as router A 105 and routers C 115-I 145.

To begin processing, switch B 110 receives a packet from a neighboring switch at a port (e.g., port 0-port 3) [step 705](FIG. 7). Router B 110 may then inspect the incoming virtual circuit identifier VCIᵢₙ in the packet header [step 710]. Router B 110 may further determine, using the incoming virtual circuit identifier VCIᵢₙ as the entry number of the VC Table 300 for this port in switch memory 215, the PNₒᵤₜ 310 [step 715] and the outgoing virtual circuit identifier VCIₒᵤₜ 315 [step 720]. Switch B 110 can replace VCIᵢₙ in the packet header with VCIₒᵤₜ [step 725]. Switch B 110 may then forward the packet to PNₒᵤₜ, PNₒᵤₜ being either an output port or IP-router processor 205 [step 730].

### Exemplary Router Packet Forwarding Processing

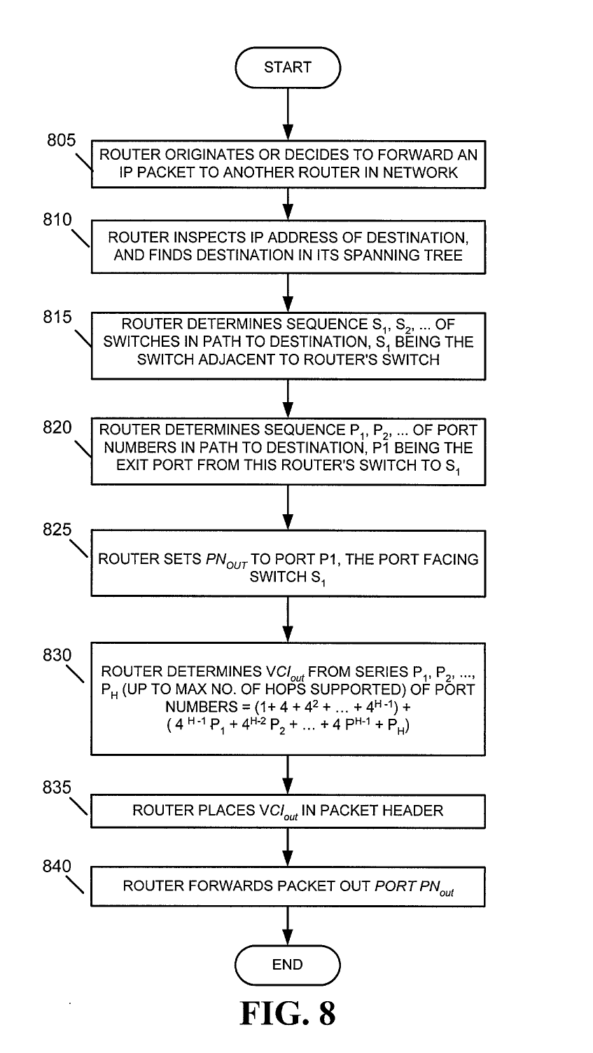

FIG. 8 is a flowchart that illustrates exemplary processing, consistent with the present invention, for originating and forwarding packets using its spanning tree of routers and the associated port numbers received in flood packets 400. As one skilled in the art will appreciate, the method exemplified by FIG. 8 can be implemented as a sequence of instructions and stored in router memory 210 of router A 105. The method exemplified by FIG. 8 may further be stored in router memory 210 of other routers in network 100, such as routers B 110-I 145.

To begin processing, router A 105 determines that an IP packet should be routed to another router in the network [step 805](FIG. 8). Router A 105 may then inspect its spanning tree [step 810] and determine a sequence S₁, S₂, . . . of switches between its switch and the destination router's switch [step 815]. Router A 105 may further determine, using the port information stored with its spanning tree, the sequence of output ports p₁, p₂, . . . between its switch and the destination router's switch [step 820], and set PNₒᵤₜ to p₁ [step 825]. Router A 105 may reduce the h entries to stay within the maximum number of hops the outgoing virtual circuits support. Then Router A 105 may compute the VCIₒᵤₜ using Eqn 2, for the correct number for routing packets through a virtual circuit out the sequence p₁, p₂, . . . , p_{H} of ports to switches S₁, S₂, . . . S_{H} to the IP-Router of switch SH [step 830], and place this VCIₒᵤₜ in the packet-switch header to the packet [step 835]. Switch A 105 may then forward the packet out port PNₒᵤₜ=p₁ [step 840].

### CONCLUSION

Systems and methods, consistent with the present invention, provide mechanisms that permit each router in the network to control the setup of a portion of its switch's virtual circuit tables according to a globally understood convention that permits each router to forward packets through multi-hop virtual circuits to routers any number of hops away (up to some limit determined by the available VC capacity), yet giving each intervening switch's router the ability to take control of, and redirect, the path of packets addressed to no-longer-connected destinations, and without requiring the use of connection-request messages.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while certain components of the invention have been described as implemented in hardware and others in software, other configurations may be possible. Also, while series of steps have been described with regard to FIGS. 5-8, the order of the steps may be altered in other implementations consistent with the present invention. No element, step, or instruction used in the description of the present application should be construed as critical or essential to the invention unless explicitly described as such. The scope of the invention is defined by the following claims and their equivalents.

What is claimed is:

1. A method of establishing virtual circuit paths at a first node in a packet-switched network, the method comprising:
receiving, at the first node, port connection information associated with switches in the network;
determining at least one virtual circuit path to at least one switch in the network based on the received port connection information; and
determining, for the at least one virtual circuit path, a first output port of the first node and an outgoing virtual circuit identifier (VCIₒᵤₜ) to use to send a packet from the first node to a destination node in the network.

2. The method of claim 1, wherein the port connection information comprises port numbers for the switches in the network.

3. The method of claim 1, wherein the outgoing virtual circuit identifier (VCIₒᵤₜ) is determined as a function of a number of hops (h) between the first node and the destination node.

4. The method of claim 3, wherein the outgoing virtual circuit identifier (VCIₒᵤₜ) for VC table entry b+e, for each value of h, is determined by:
VCIₒᵤₜ=2+4¹+, . . . +4^{h-2}+((e−b)mod 4^{h-2})
where b=2+4¹+ . . . +4^{h-1} and e<4^{h}

5. A router comprising:
at least one network interface configured to:
receive port connection information associated with switches in a network; and
at least one processor configured to:
determine at least one virtual circuit path to at least one switch in the network based on the received port connection information, and
determine, for the at least one virtual circuit path, a first output port of the first node and an outgoing virtual circuit identifier (VCIₒᵤₜ) to use to send a packet from the router to a destination node in the network.

6. The router of claim 5, wherein the port connection information comprises port numbers for the switches in the network.

7. The router of claim 5, wherein the outgoing virtual circuit identifier (VCIₒᵤₜ) is determined as a function of a number of hops (h) between the router and the destination node.

8. The router of claim 7, wherein each outgoing virtual circuit identifier (VCIₒᵤₜ) for VC table entry b+e, for each value of h, is determined by:
VCIₒᵤₜ=2+4¹+ . . . +4^{h-2}+((e−b)mod 4^{h-2})
where b=2+4¹+ . . . +4^{h-1} and e<4^{h}

9. A computer-readable medium containing instructions for controlling at least one processor to perform a method of establishing virtual circuit paths at a first node in a packet-switched network, the method comprising:
receiving, at the first node, port connection information associated with switches in the network;
determining at least one virtual circuit path to at least one switch in the network based on the received port connection information; and
determining, for the at least one virtual circuit path, a first output port of the first node and an outgoing virtual circuit identifier (VCIₒᵤₜ) to use to send a packet from the first node to a destination node in the network.

10. A method of updating a virtual circuit table associated with a first switch in a packet-switched network, comprising:
receiving port connection information associated with switches in the network;
updating previously stored information regarding locations and paths to switches in the network based on the received port connection information; and
updating, based on the received port connection information, entries in the virtual circuit table such that the first switch provides virtual circuit paths to all switches in the network within a radius of connection from the first switch, and terminating all virtual circuits that the router deems unusable due to open ports or path reversals.

11. The method of claim 10, wherein the port connection information comprises port numbers for the switches in the network.

12. The method of claim 10, wherein the virtual circuit table comprises outgoing virtual circuit identifier (VCIₒᵤₜ) entries and wherein the outgoing virtual circuit identifier (VCIₒᵤₜ) entries are determined as a function of a number of hops (h) between the first node and possible destination nodes and the sequence of port numbers.

13. The method of claim 12, wherein each outgoing virtual circuit identifier (VCIₒᵤₜ) for VC table entry b+e, for each value of h, is determined by:
VCIₒᵤₜ=2+4¹+ . . . +₄^{h-2}+((e−b)mod 4^{h-2})
where b=2+4¹+ . . . +4^{h-1} and e<4^{h}

14. A router comprising:
at least one network interface configured to:
receive port connection information associated with switches in a network; and
at least one processor configured to:
update information pertaining to locations and paths to switches in the network based on the received portion connection information, and
update, based on the received port connection information, entries in a virtual circuit table such that the router provides virtual circuit paths to all switches in the network within a radius of connection from the router.

15. The router of claim 14, wherein the port connection information comprises port numbers for the switches in the network.

16. The router of claim 14, wherein the virtual circuit table comprises outgoing virtual circuit identifier (VCIₒᵤₜ) entries and wherein the outgoing virtual circuit identifier (VCIₒᵤₜ) entries are determined as a function of a number of hops (h) between the first node and possible destination nodes.

17. The router of claim 16, wherein each outgoing virtual circuit identifier (VCIₒᵤₜ ) for VC table entry b+e, for each value of h, is determined by:
VCIₒᵤₜ=2+4¹+ . . . +4^{h-2+((}e−b)mod 4^{h-2})
where b=2+4¹+ . . . +4^{h-1} and e<4^{h}

18. A computer-readable medium containing instructions for controlling at least one processor to perform a method of updating a virtual circuit table associated with a first switch in a packet-switched network, the method comprising:
receiving port connection information associated with switches in the network;
updating knowledge of locations and paths to switches in the network based on the received portion connection information; and
updating, based on the received port connection information, entries in the virtual circuit table such that the first switch provides virtual circuit paths to all switches in the network within a radius of connection from the first switch.

19. A system for updating a virtual circuit table associated with a first switch in a packet-switched network, the system comprising:
means for receiving port connection information associated with switches in the network;
means for updating knowledge of locations and paths to switches in the network based on the received portion connection information; and
means for updating, based on the received port connection information, entries in the virtual circuit table such that the first switch provides virtual circuit paths to all switches in the network within a radius of connection from the first switch.
